(19) United States
(12) Patent Application Publication
(10) Pub. No.: US 2004/0197520 A1
(43) Pub. Date: Oct. 7, 2004

(54) Alternative to viscose flocking

(76) Inventor: Frederick Hall, Victoria (AU)

Correspondence Address: Edwin D Schindler, Five Hirsch Avenue, PO Box 966, Coram, NY, 11727-0966, US

(21) Appl. No.: 10/485,887

(22) PCT Filed: Aug. 1, 2002
(86) PCT No.: PCT/AU02/01017

(30) Foreign Application Priority Data
Aug. 1, 2001 (AU) PR 6757

(51) Int. Cl. B05D 3/12; B32B 33/00

(52) U.S. Cl. 428/85; 427/180; 427/189; 427/359; 442/59

(57) ABSTRACT

A method for manufacturing a fabric coating, which simulates a viscose flocking finish, relative to at least one layer of the fabric coating, and which is particularly relevant to crushed foam coatings, includes the steps of providing fine beads of polymer, which are hollow and partially filled with selected solvents, or solvent blends or other volatile substances, and adding these beads to a coating compound in its wet state. Thereafter, coating the fabric with the resultant compound and oven drying the resulting compound on the fabric, then raising the temperature of the coating to crosslink the polymer and expand the polymer beads within the coating layer. The fabric coating produced by the method, and a fabric coated with the fabric coating made by the method, are also claimed.

### Technical Area

This invention relates to the area of protective coatings for fabrics and in particular for fabrics which are intended to be exposed to ultraviolet radiation such as curtain materials, blinds and the like. These coatings also have thermal insulating properties.

### BACKGROUND TO THE INVENTION

Although protective coatings can be applied to most fabrics including any window covering fabrics, building panels or substrates and for many applications other than for curtaining material for convenience sake the coating discussed here will be discussed in terms of its application to curtain material.

Unlined curtain fabrics require a coating on the side facing towards a window as do curtain liners in order to protect the fabric from degradation by ultraviolet light and to control the amount of light transmitted through the fabric. This protection is usually in the form of a crushed pigmented polymer foam which is applied to one side of the fabric. The pigment provides the UV light barrier while the crushed polymer foam is the carrier for the pigment.

Crushed polymer foam is the most common form of pigment carrier due to its natural softness and ability to drape naturally. It may be semi opaque or totally opaque depending on the desired degree of light transmission.

Most crushed polymer foam used in the drapery industry is a pigmented acrylic polymer which in its finished form has a somewhat plastic appearance and feel and it has been found over the years that the purchasing public finds the product more acceptable when a light coating of viscose flock is added to the crushed polymer foam surface. There are however some problems with this type of finish.

The fine flock finish can trap dust which is undesirable however it can also shed and come free from the curtain surface and fall on other surfaces in a room. There have been some concerns also that flock particles, which are easily airborne, may cause an inhalation health hazard e.g. concerns about asthma and for that reason some manufacturers and distributors are loth to use flock and have returned to producing the less appealing product without it.

### OUTLINE OF THE INVENTION

It is an object of this invention to provide a means whereby a fabric surface can be provided with appearance and feel approaching that of a flocked surface, to minimise any plastic look or feel, without using viscose flocking with its attendant problems.

The invention in one aspect is a method of manufacturing a fabric coating which simulates a viscose flocked finish which method, in relation to at least one layer of the fabric coating, includes the steps of:

providing fine beads of polymer which are hollow and partially filled with selected solvents or solvent blends or other volatile substances;

adding these beads to a coating compound in its wet state;

coating the fabric with the resultant compound;

oven drying the compound on the fabric and raising the temperature of the coating to crosslink the polymer and expand the polymer beads within the coating layer;

Where the coating compound used is a polymer for foaming it is preferred that the compound be foamed after the addition of the beads to it.

It is preferred also that the coated fabric be passed through a crushing roller after oven drying and prior to raising the temperature of the coating where a polymer for foaming is used.

It may be preferred that the crosslinked, coated fabric be passed through or around cooling rollers to complete the process. In may be further preferred that the crossiinking of the polymer and expansion of the polymer beads be accomplished by heating in a second oven in line or by cooling and rewinding the coated fabric and passing it through an oven at a later time.

The invention in another aspect is a fabric coating formed by the method described above.

The quantity of beads added to the coating compound is preferably of the order of between 1% to 10% dry weight of polymer beads relative to the dry weight of the crushed polymer foam although a more preferred range is between 2% and 5%.

In order that the invention may be more readily understood we will describe by way of non limiting example a specific embodiment thereof.

### DESCRIPTION OF A PREFERRED EMBODIMENT OF THE INVENTION

In the embodiment of the invention described here an alternative to the viscose flocked finish common on crushed polymer foam surfaces used on fabrics is achieved by the addition of between 2% and 5% by weight of fine polymer beads to a foaming polymer coating compound prior to its application to fabric and subsequent foaming, drying and crushing.

The percentage range of beads given is a preferment and it is envisaged that an acceptable surface could still be obtained outside this range. We have found however that the best effect is achieved using a fine bead in the percentage range given above.

Where a high percentage of beads are used the effect is more pronounced.

The type of fine bead used is a hollow polymer bead which is partially filled with selected solvents or solvent blends or other volatiles. The beads are stirred into the coating compound in its liquid form and applied to the fabric usually by blade coating prior to heating and drying such that the beads are located within the coating layer If the coating was applied as a foam then the dried foam is crushed by roller.

Passing the dried coating through a second oven either immediately or at a later time causes the polymer shells of the beads to soften while the solvent within them boils. The elevated temperature has the effect of crosslinking the polymer used in the coating and also of expanding the beads within and at the surface and both steps can be carried out simultaneously by choosing a suitable temperature and heating time.

The expansion of the beads is retained once the coating has cooled and the operation is completed once the coated fabric passes through a cooling roller or is cooled by other means.

It is also customary to apply a silicone coating or other lubricant to the finished product in order to provide the coated surface with some slip properties however this is not an essential feature of the invention.

The resultant fabric coating obtained has a visual and textural appearance and feel which is at least the equal of conventionally flocked coatings and may be seen in fact to be an improvement and it is particularly so compared to an unflocked surface. Its most important superiority over conventional flocked surfaces however is that the fabric coating of the invention is stable and does not shed thereby avoiding any problems which may be associated with the tendency of conventional flocked surfaces to shed their flocking and any health hazard this may cause.

The fabric may be treated with a single layer of coating material incorporating the beads or, alternatively, two or three coats at least one of which would contain beads as described. If the beads are in an outer coating the resultant coating will be strongly textured, however if they are in an inner layer such a texture would be largely lost. In any event the presence of the beads impregnated in any of the layers gives the feel and cushioning effect of a thicker material and is softer than ordinary flocked fabrics.

It is envisaged that where more than one layer of coating is used these may be of different colours.

It is further envisaged that a radiatively absorptive layer of a dark colour could be used for total opacity and that this coloured layer could be sandwiched between layers of lighter colours such that the fabric colours are not affected and neither are the radiative properties of the coating surface.

Whilst we have described herein one specific embodiment of the invention it is envisaged that other embodiments of the invention will exhibit any number of and any combination of the features previously described and that variations and modifications of these can be made without departing from the spirit and scope of the invention.

1-22 (canceled)

23. A method for manufacturing a fabric coating having a simulated viscose flocked finish, comprising the steps of:
providing fine beads made of a polymer and being hollow;
partially filling said fine beads with a volatile substance for forming partially filled hollow beads;
adding said partially filled hollow beads to a coating compound, said coating compound being in a wet state, for forming a resultant compound;
coating a layer of fabric with said resultant compound; and,
oven drying said resultant compound on said layer of fabric; and,
crosslinking said polymer and expanding said partially filled hollow beads within said layer of fabric via heating at a temperature which is greater than a temperature for said oven drying said resultant compound on said layer of fabric.

24. The method for manufacturing a fabric coating having a simulated viscose flocked finish according to claim 23, wherein a quantity of said partially filled hollow beads added to said coating compound during said step of adding is between 1%-10%, by weight, of said partially filled hollow beads relative to a weight of said coating compound.

25. The method for manufacturing a fabric coating having a simulated viscose flocked finish according to claim 23, wherein a quantity of said partially filled hollow beads added to said coating compound during said step of adding is between 2%-5%, by weight, of said partially filled hollow beads relative to a weight of said coating compound.

26. The method for manufacturing a fabric coating having a simulated viscose flocked finish according to claim 23, wherein said coating compound is a polymer.

27. The method for manufacturing a fabric coating having a simulated viscose flocked finish according to claim 23, further comprising the step of:
foaming said coating compound after said step of adding said partially filled hollow beads to said coating compound, said coating compound being a polymer for foaming.

28. The method for manufacturing a fabric coating having a simulated viscose flocked finish according to claim 27, further comprising the step of:
passing said layer of fabric through a crushing roller after said step of oven drying and prior to said step of crosslinking said polymer and expanding said partially filled hollow beads within said layer of fabric via heating.

29. The method for manufacturing a fabric coating having a simulated viscose flocked finish according to claim 23, further comprising the step of:
passing said layer of fabric through a cooling roller after said step of crosslinking said polymer and expanding said partially filled hollow beads within said layer of fabric via heating.

30. The method for manufacturing a fabric coating having a simulated viscose flocked finish according to claim 29, further comprising the step of:
rewinding said layer of fabric after said step of crosslinking said polymer and expanding said partially filled hollow beads within said layer of fabric via heating; and,
passing said layer of fabric, after said step of rewinding, through an oven for additional oven drying.

31. The fabric coating made by the method of claim 23.

32. The fabric coating made by the method of claim 24.

33. The fabric coating made by the method of claim 25.

34. The fabric coating made by the method of claim 26.

35. The fabric coating made by the method of claim 27.

36. A fabric, comprising:
a fabric coating having a simulated viscose flocked finish, said fabric coating made from a method for manufacturing comprising the steps of:
providing fine beads made of a polymer and being hollow;
partially filling said fine beads with a volatile substance for forming partially filled hollow beads;
adding said partially filled hollow beads to a coating compound, said coating compound being in a wet state, for forming a resultant compound;
coating a layer of fabric with said resultant compound; and,
oven drying said resultant compound on said layer of fabric; and,
crosslinking said polymer and expanding said partially filled hollow beads within said layer of fabric via heating at a temperature which is greater than a temperature for said oven drying said resultant compound on said layer of fabric.

37. The fabric according to claim 36, wherein a quantity of said partially filled hollow beads added to said coating compound during said step of adding during said method for manufacturing is between 1%-10%, by weight, of said partially filled hollow beads relative to a weight of said coating compound.

38. The fabric according to claim 36, wherein a quantity of said partially filled hollow beads added to said coating compound during said step of adding of said method for manufacturing is between 2%-5%, by weight, of said partially filled hollow beads relative to a weight of said coating compound.

39. The fabric according to claim 36, wherein said coating compound of said method for manufacturing is a polymer.

40. The fabric according to claim 36, wherein said method for manufacturing further comprises the step of:
foaming said coating compound after said step of adding said partially filled hollow beads to said coating compound, said coating compound being a polymer for foaming.
